(19) United States
(12) Patent Application Publication
(10) Pub. No.: US 2024/0154521 A1
(43) Pub. Date: May 9, 2024

(54) METHOD AND CIRCUIT FOR CONTROLLING CHARACTERISTICS OF THE INPUT CURRENT TO AN ELECTRONIC POWER SUPPLY

(71) Applicant: Anton Werner Keller, Arni (CH)

(72) Inventors: Anton Werner Keller, Arni (CH); Lukas Jonas Hausammann, Staufen (CH)

(21) Appl. No.: 18/548,899

(22) PCT Filed: Jan. 31, 2022
(86) PCT No.: PCT/IB2022/050804

§ 371 Date: Sep. 3, 2023

(30) Foreign Application Priority Data
Feb. 3, 2021 (DE) 10 2021 102 441.2

(51) Int. Cl. H02M 1/42; H02M 1/00; H02M 3/158

(52) U.S. Cl. CPC H02M 1/4225; H02M 1/0019; H02M 3/158

(57) ABSTRACT

A method of operating a switched-mode power factor correction circuit comprises receiving a first input signal representing a momentary AC input voltage, and operating under control of a power factor controller a boost switch for charging an output capacitor of the PFC circuit. The boost switch is controlled in accordance with the first input signal so as to cause a current flow that has a waveform targeted to correspond to a scaled version of the waveform of the AC input voltage. A second input signal received at the power factor controller, modifies the operation of the boost switch, targeting to cause a current flow that, during an AC input voltage half-wave having non-zero input current, has a waveform that at least partially or temporarily not corresponds to a scaled version of the waveform of the AC input voltage.

### FIELD

The present invention relates to electronic power supplies operated off the electric AC power grid, more specifically to a method of controlling characteristics of the input current to the electric power supply, also referred to as power factor correction, and to an apparatus adapted to execute the method.

### BACKGROUND

Electronic power supplies operated off the AC power grid are widely used in all sectors of the industry. Most electronic power supplies represent non-linear loads to the AC power grid, i.e., the waveform of the current is not a scaled replica of the waveform of the voltage, as would be the case for a purely resistive load.

Electronic power supplies typically rectify the AC input voltage and provide a DC output voltage to the load. Usually, such AC-DC power supplies feature a rectifier, e.g., one or more diodes, which produce a DC voltage at their output that oscillates with twice the AC frequency. Capacitors at the output of the rectifier store the rectified current and provide a relatively stable DC voltage, depending on the current drawn by the electric or electronic appliance and the capacity of the capacitors. If the power supply is connected to an AC power grid and an output voltage different from the AC grid voltage is desired, transformers may be used for transforming the AC voltage prior to rectifying, or DC-DC converters may be used for providing the desired output voltages.

In order to reduce the size of the transformers, switched-mode power supplies are used. Switched-mode power supplies rectify the AC input current in a half-wave or full-wave rectifier and store the energy in an input capacitor. The input capacitor can maintain a voltage of approximately the peak voltage of the input sine wave of the AC input voltage between two peaks of subsequent sine waves, depending on the DC current drawn from the storage capacitor between two peaks of the input voltage sine waves. The DC power stored in the capacitor is then fed to a transformer via a switch that intermittently cycles the current through the transformer. The reduction of the size of the transformers is achieved because the current into the transformer is controlled to never reach a level that saturates the transformer core. The small amount of energy that can be transferred during one on-off cycle is compensated for by cycling at high frequency, much higher than the frequency of the AC voltage. When only little power is drawn from the load, a current that recharges the capacitor may only flow at or near the peak AC voltage, and this pulse of current must contain enough energy to sustain the load until the next peak. It is easy to see that the resulting input current waveform does not represent a scaled version of the voltage.

These AC-DC power supplies, like other electric or electronic loads such as some forms of electric lighting, electric arc furnaces, welding equipment, variable speed drives and the like, represent so-called non-linear loads, since the input current waveform does not correspond to the AC input voltage waveform, the latter typically being sinusoidal. Non-linear current waveforms may result in large harmonic currents oscillating in the power grid, which may cause energy loss and cause interference that could disturb the operation of other devices, notably those that are powered from the same AC power grid. The magnitude of the harmonic currents typically increases with the power of the electric or electronic appliance.

Regulators have attempted to control and limit the undesired consequences of line-frequency harmonics on the AC power grid and, accordingly, regulatory requirements have been stipulated. The IEC61000-3-2 international standard, for example, stipulates the maximum permissible amplitudes of line-frequency harmonics up to the 39^{th} harmonic. This requirement applies to most electrical appliances having an input power of 75 W (Class D equipment) or greater. The number and magnitude of harmonics present in the supply current may be compared with the sinusoidal AC input voltage and may be referred to as power factor. The power factor of an AC electrical power system is defined as the ratio of the real power absorbed by the load to the apparent power flowing in the circuit, and is a dimensionless number in the closed interval of −1 to 1. A power factor of less than one indicates that the voltage and current are not in phase or that the current is not sinusoidal, respectively.

Some reduction of the harmonics caused by non-linear loads may be obtained by filters that include capacitors or inductors, and which can prevent harmonic currents from entering the AC power grid. However, these filters may be bulky and can typically only be designed for a reasonably constant load.

A more flexible approach to comply with the requirements that limit the amplitude of line-frequency harmonics at the interface between the AC power grid and the input of the electronic power supply is found in active power factor correction circuits that are provided between the AC power grid and the input to the electronic power supply. A commonly used boost-type power factor correction circuit comprises an inductor and a switch, which are controlled to draw an input current that—on average—corresponds in phase and frequency with the input voltage, and that produces a more or less constant DC output voltage that is higher than the peak voltage of the AC power grid. The DC output voltage of the power factor correction circuit is then supplied to a switched-mode DC-DC converter, which produces the desired output voltages of the electronic power supply. This DC-DC converter may be of any known configuration, i.e., boost, buck, or buck-boost. A low-pass filter at the input of the power factor correction circuit removes high-frequency transients caused by the switching itself.

The power factor correction circuit causes some additional power losses in its components, inter alia in the switch and in components required for sensing the switch current. Losses attributable to the switch, typically a MOSFET, are the switching losses that occur during switching on and switching off of the switch, and the losses due to the non-zero impedance of the closed, i.e., conducting switch. In particular the switching losses increase with the switching frequency, and there are some strategies to reduce the losses and increase the efficiency. Some of these strategies involve controlling the switch to open or close whenever the voltage or the current are at or near zero. Other strategies include skipping switching during one or more half-waves whenever the load is low. The “Power Factor Correction (PCF) Handbook” issued by ON Semiconductor, document no. HBD853/D, Rev. 5, April 2014 (https://www.onsemi.com/pub/Coliateral/HBD853-D.PDF) provides an overview of state-of-the-art solutions for improving the efficiency of PFC circuits and concepts.

While the existing solutions provide high-quality power factor correction and comparatively good efficiency, there remains a need for further improving the efficiency of the PFC circuit.

### SUMMARY OF THE INVENTION

It is an object of the present invention to provide a power factor correction circuit capable of providing power factor correction that is compliant with regulatory requirements at a high efficiency, and a corresponding method of operating the power factor correction circuit. It is a further object of the present invention to provide an electronic power supply comprising a power factor correction circuit in accordance with the present invention and a DC-DC-switch mode power supply.

In accordance with a first aspect of the present invention a method of operating a switched-mode power factor correction circuit of an electronic power supply comprises receiving a first input signal representing a momentary AC input voltage at the power factor correction circuit or at the input of the power supply. A sequence of momentary AC input voltage values over time may correspond to an AC input voltage waveform, which typically is sinusoidal. In this context the term waveform is used for a sequence of values over time, unless otherwise noted or obvious from the respective context. If the frequency and the waveform of the AC input voltage are known and known to be very stable, the first input signal may also be a stored representation of the AC input waveform, values of which are received in a fashion synchronized with the actual AC input voltage, i.e., with their periods matched in length and their zero-crossings coinciding. The method further comprises operating a boost switch for charging an output capacitor of the PFC circuit. The boost switch is operated under control of a power factor controller of the PFC, which power factor controller may also receive the first input signal. If the first input signal corresponds to the AC input voltage at the input of the power supply the level of the signal may need to be shifted in order to be processed by the power factor controller, or the first signal may need to be rectified. The boost switch is be connected to a storage inductor, which discharges a current flowing in the inductor to the output capacitor through a diode or a switch. The boost switch is operated at a frequency that is higher than a frequency of the AC input voltage. The operation of the boost switch, under control of the power factor controller, causes a current flow, at the input of the power supply, that has a waveform targeted to correspond to a scaled version of the waveform of the AC input voltage as represented by the first input signal, when no second control signal is received at the PFC circuit. In this context the term scaled may be understood as having a similar overall shape, while the magnitude may be different. The similar overall shapes may be made congruent by applying a linear scaling, e.g., by multiplying with a factor. The method yet further comprises receiving a second input signal at the PFC circuit that modifies the operation of the boost switch, targeting to cause a current flow, at the input of the power supply, that, during an input voltage half-wave having non-zero input current, has a waveform that at least partially or temporarily not corresponds to a scaled version of the waveform of the AC input voltage. In this context the transient currents during switching the boost switch from off to on or from on to off are ignored and will typically be filtered by an input filter of the PFC circuit or even by stray capacitances and inductances and will not appear at the input to the PFC circuit.

The second input signal may be received at the power factor controller of the PFC circuit and may cause the power factor controller to operate the boost switch in at least two different operating modes during corresponding sections of a half wave of the AC input voltage. An operating mode in this context may refer to the shape of the input current waveform that is caused by the operation of the boost switch in response to the first input signal alone or in response to the second input signal alone or together with the first input signal.

Accordingly, in a first one of the operating modes during which the boost switch is operative the input current to the PFC circuit has a waveform that is targeted to correspond to a scaled version of the waveform of the AC input voltage. During this operating mode the second input signal may actively cause a normal operation of the PFC circuit, or may simply be absent.

In a second one of the operating modes during which the boost switch is operative the input current to the PFC circuit also has a waveform that is targeted to correspond to a scaled version of the waveform of the AC input voltage, albeit at a different scaling factor. During this operating mode the second input signal may cause the power factor controller to perform a quasi-normal operation of the PFC circuit, and the second input signal may set the scaling factor.

In a third operating mode during which the boost switch is operative the second input signal may cause the control circuit to control the boost switch during a portion of an input voltage half-wave, e.g., during a section of a rising and/or falling slope of a half-wave, such that the waveform of the input current to the power supply during this time rises linearly, step-wise, or has any other shape that is not similar to the AC input voltage waveform. It goes without saying that the second input signal may cause combinations of linearly rising sections and step-wise rising sections, or may cause such sections to follow each other. Again, the section during which the control circuit controls the boost switch to cause an input current to have a waveform that rises linearly or step-wise, or takes any other shape that is not similar to the AC input voltage waveform may be located next to a point when the AC input voltage crosses zero. However, such sections may also occur at other points of a half wave.

The second control signal may also cause the power factor controller to keep the boost switch inoperative during a portion of an input voltage half-wave, e.g., during a section of a rising and/or falling slope of a half-wave, such that the input current of the PFC circuit is zero during this time or is determined only by a difference between the momentary AC input voltage and the voltage present at the output capacitor. In the latter case the current may simply flow through a rectifier diode that is provided in the PFC circuit for charging the output capacitor. The section during which the control circuit controls the boost switch to be inoperative may be located next to a point when the AC input voltage crosses zero.

All of the first, second and third operating modes may be present during one half wave of the AC input voltage, and may follow each other. The portions of the first, second and third operating modes over half waves may vary depending on the load and other factors, including the type of power factor controller used in the PFC circuit.

The present method exploits the fact that typical regulatory rules and stipulations do not demand that the power factor must be exactly one or at least very close to one, but provides a certain tolerance range. For example, at certain points or during certain periods during a half-wave of the AC input voltage operating the boost switch at a fixed frequency and with a fixed maximum on-time, as is the case with many off-the-shelf PFC controller circuits, may result in an input current waveform that closely resembles the AC input voltage waveform at these points or during these periods. However, doing so may not contribute significantly to charging the output capacitor, e.g., when the AC input voltage is close to a point when it crosses zero, while nevertheless causing switching and other losses. Inhibiting the operation of the boost switch at these points or during these periods and making up for the energy that therefore had not been stored in the output capacitor when the boost switch is operated again may cause slightly larger harmonics, or a lower power factor, which, however, may still lie within the regulatory rules or stipulations. In any case the modified operation of the boost switch may result in lower losses in the PFC circuit.

A similar effect may be seen when the second input signal modifies the operation of the boost switch in such a way that the waveform of the input current to the PFC circuit takes a shape that has larger harmonics, or a lower power factor, but allows for controlling the boost switch in a manner that reduces the switching and/or other losses. This may be the case for a linearly or step-wise rising input current, which may require fewer switch cycles of the boost switch, switch cycles that are spaced further apart from each other, and/or a lower switching frequency, thereby reducing the switching losses in the boost switch. During any of the overall fewer switch cycles within a half-wave the boost switch may be conducting for a longer period, thus storing more energy in the inductor. Doing so will inevitably create more harmonics, which may, however, still lie within the boundaries of the regulations and rules.

The reduced losses in the PFC circuit will relax the cooling requirement for the boost switch and other components, which may be considered when designing the PFC circuit, e.g., by designing smaller heatsinks or lower power fans or the like. The savings so achieved not only reduce the overall cost of the PFC circuit, but may also reduce the environmental impact of the PFC circuit, as less material may be used.

In accordance with one or more embodiments of the method receiving the second signal at the PFC circuit comprises receiving a second signal, or a variant thereof, that has been selected or modified in accordance with an output load of the PFC circuit or of a power supply connected to the output of the PFC circuit.

This embodiment recognizes that different PFC circuits may produce different amounts of harmonics under different load conditions, and selects or modifies a second input signal that controls the operation of the boost switch targeting to cause an input current flow having a waveform that, while not having the minimum possible number and/or magnitude of harmonics, still meets the regulatory rules and stipulations. This embodiment also exploits the fact that the maximum number and/or magnitude of the harmonics may be different for different power levels, or loads. One of a number of second input signals stored in a memory may be selected to match a current output power or output power range. A signal corresponding to the output load may be provided by a load connected to the PFC circuit, e.g., a switch mode power supply connected to the output capacitor of the PFC circuit, or may be derived from the speed with which the voltage at the output capacitor of the PFC circuit decreases over time between two half-waves or between two subsequent switching periods of the boost switch. Other ways of determining signals indicative of the output load are conceivable and are not described herein in detail.

In accordance with one or more embodiments the second input signal is targeted to cause a waveform of the current flow, at the input of the power supply, to be symmetrical over a half-wave.

In accordance with one or more embodiments the method further comprises analyzing the harmonics of the waveform of the input current to the PFC circuit or to the power supply during at least a portion of a present half-wave of the AC input voltage. The results of the analysis may than be used for selecting or generating the second input signal that is received at the PFC circuit for the remaining portion of the half-wave of the AC input voltage in accordance with a power-dependent maximum permissible harmonic current amplitude per Watt and/or a maximum permissible harmonic current, targeting to stay below the maximum permissible harmonic current per Watt output power and/or the maximum permissible harmonic current amplitude, for each harmonic, averaged over the entire half-wave of the AC input voltage. The analysis may, e.g., be performed on the first half of a half-wave, and the results of the analysis may be used for controlling the boost switch during the second half-wave targeted to ensuring that the number and/or magnitude of the harmonics for the entire half-wave stay below the permissible limits, all while controlling the boost switch in such a way that the switching losses and/or the conducting losses in the PFC circuit are lower when compared to operating the boost switch for obtaining a best possible power factor, or lowest possible harmonics.

In one or more embodiments the second control signal may be dynamically variable from one half-wave to a subsequent half-wave, or even within the same half-wave, for obtaining the specific waveform that partially or temporarily not corresponds to a scaled version of the AC input voltage waveform, while still ensuring that the harmonics stay below the maximum permissible values. This includes continuously modifying the second control signal, attempting to ensure that the harmonics over the entire half-wave stay below the maximum permissible values.

In accordance with one or more embodiments the method further comprises analyzing the harmonics of the waveform of the input current to the PFC circuit or to the power supply during at least the preceding half-wave of the AC input voltage. Analyzing may comprise, for example, performing an FFT or determining the RMS-value of the input current. The results of the analysis may than be used for selecting or generating the second input signal received at the PFC circuit for the present half-wave of the AC input voltage in accordance with a power-dependent maximum permissible harmonic current amplitude per Watt and/or a maximum permissible harmonic current, targeting to stay below the maximum permissible harmonic current per Watt output power and/or the maximum permissible harmonic current amplitude, for each harmonic, averaged over the entire half-wave of the AC input voltage. Like in the previous embodiment the quasi-continuous analysis of the input current allows for modifying or controlling the operation of the boost switch in such a way that that the number and/or magnitude of the harmonics for the entire half-wave stay below the permissible limits, all while controlling the boost switch in such a way that the switching losses and/or the conducting losses in the PFC circuit are lower when compared to operating the boost switch for obtaining a best possible power factor, or lowest possible harmonics. This embodiment may be particularly useful in case the load changes only very slowly, and may permit reducing the margin between the permissible harmonic content and the actual harmonic content as determined in the analysis.

In accordance with one or more embodiments values, algorithms or curves describing the maximum permissible harmonic current per Watt output power and/or the maximum permissible harmonic current amplitude for each harmonic, may be stored in a memory and provided to the analyzer and/or the control circuit. Different values, algorithms or curves may be provided for different loads, for different regions in which the method may be executed, or the like. The values, algorithms or curves stored in the memory may be replaced or updated, e.g., via a corresponding interface, which may be useful in case of changed regulations or use in a region having different regulations. Replacing or updating may be done via a wired or wireless interface.

The closed-loop control proposed in this embodiment may make better use of the limits for the amount and magnitudes of harmonics stipulated in the regulations, e.g., in IEC 61000-3-2, while reducing the losses in the PFC circuit to the maximum possible. The closed-loop control also allows for better tracking fluctuations or variations in the output load, thereby facilitating staying within the regulatory limits for harmonics.

Embodiments using closed-loop control may also provide what could be dubbed “soft start” in terms of harmonics, i.e., the PCF circuit may first be operated to provide a power factor that is as close to one as possible, and only after any initial transient changes in the output load have settled will the analyzer circuit try to detect properties of the power factor controller used in the circuit and increase the number and magnitudes of the harmonics while staying below the regulatory limits.

In accordance with a second aspect of the present invention a PFC circuit of an electric power supply that is connected to an AC voltage source comprises an input filter, an inductor, a boost switch, a rectifier switch and an output capacitor. The rectifier switch may be a diode or an actively controlled switch, e.g., a transistor. The PFC circuit further comprises a power factor controller that receives, at a first input, a first input signal representing a momentary AC input voltage. The power factor controller is adapted to control the operation of the boost switch targeting to cause a current flow, at the input of the power supply, to have a waveform that corresponds to a scaled version of the waveform of the AC voltage source as represented by the first input signal. The PFC circuit is characterized in that the power factor controller is adapted to receive, at the first input or at a second input, a second input signal that controls or modifies the operation of the boost switch targeting to cause a current flow, at the input of the power supply, that, during an input voltage half-wave having non-zero input current, has a waveform that at least partially not corresponds to a scaled version of the waveform of the AC voltage source.

If the second input signal is received at the first input of the power factor controller the signal may distort or modify the first input signal in such a way that the resulting signal causes a current flow, at the input to the PFC circuit, that has a waveform that does not correspond to a scaled version of the waveform of the AC voltage source. For example, the first and the second input signals may be added to each other or multiplied with each other to produce a resulting signal having the desired effect, and the second input signal may have a corresponding waveform.

Alternatively, if the second input signal is received at a second input of the power factor controller the signal may be internally switched or routed to at least temporarily replace the first input signal, controlling the operation of the boost switch targeting to cause a waveform of the input current of the power supply that does not correspond to the waveform of the AC input voltage. Alternatively, or in addition, the second input signal may cause a change in an operating frequency of the boost switch whenever the second input signal replaces or modifies the first input signal.

Irrespective of whether the second input signal is received at the first or the second input of the power factor controller the second input signal may be received or effective only when a modified operation of the boost switch is required, and may not be received at other times, which effectively causes the PFC circuit to operate in a generally known manner whenever the second input signal is not received or is ineffective.

In one or more embodiments the PFC circuit further comprises a current sensing means that is adapted to measure a current flowing in the inductor, an analyzer circuit, coupled to the current sensing means and receiving the first input signal S1, and a control circuit that is coupled to an output of the analyzer circuit and to a second input of the power factor controller. The analyzer circuit is adapted to determine harmonics in the current flowing through the inductor. The control circuit is adapted to select or generate the second input signal in dependence of a number of harmonics in the current flowing through the inductor and a power-dependent maximum permissible harmonic current amplitude per Watt output power and/or a maximum permissible harmonic current amplitude.

An electric power supply in accordance with a third aspect of the invention comprises an input coupled to an AC input voltage source, an output coupled to a non-linear load, and a power factor correction circuit according to one or more embodiments of the second aspect of the invention.

### BRIEF DESCRIPTION OF THE DRAWINGS

In the following section the invention will be described with reference to the attached drawings, in which

FIG. 1 shows an exemplary schematic diagram of a generally known PFC circuit,

FIG. 2 shows an exemplary schematic diagram of a PFC circuit in accordance with one or more aspects of the present invention,

FIG. 3 shows various simplified exemplary input current waveforms of the PFC circuit, caused by applying different second signals to the power factor controller in accordance with the invention,

FIG. 4 shows a flow chart of an exemplary embodiment of a method of operating a PFC circuit in accordance with present invention, and

FIG. 5 shows a more detailed flow chart of the controlling or modifying step of FIG. 4.

In the figures identical or similar elements are referenced by the same reference designators.

### DETAILED DESCRIPTION OF EMBODIMENTS

FIG. 1 shows an exemplary schematic diagram of a generally known PFC circuit 200. An AC input voltage is applied at an input 202 to an input rectifier 204. An input capacitor 206 stores the rectified input voltage. However, input capacitor 206 has a very small capacitance only, in order to allow the waveform of the input current to follow the waveform of the AC input voltage, and also does not significantly influence or distort the waveform of the rectifier AC input voltage. A first input signal S1 is tapped off at the output of rectifier 204 and provided to a PF controller circuit 214 as a reference signal representing the momentary AC input voltage at the PFC circuit 200. PF controller circuit 214 is connected to a control input of a boost switch 212, e.g., a MOSFET or any other switch, preferably an electronic switch. An inductor 208 is connected between an output of input rectifier 204 and an input of boost switch 212. An output of boost switch 212 is coupled to ground potential, e.g., the low output potential of input rectifier 204, via a current sense resistor 216. Current sense resistor 216 may be provided for sensing a momentary current through boost switch 212. The sensed momentary current may be used, inter alia, for implementing an overcurrent protection in a generally known manner. Instead of providing a separate resistor, current sense resistor 216 may also be formed by the on-resistance of the boost switch, or may be implemented elsewhere in the current path. The output of inductance 208 is further coupled to an input of a boost rectifier 210, which may be implemented by a diode or an actively controlled rectifier. An output capacitor 218 is coupled to an output of boost rectifier 210. Output capacitor 218 has a capacity that is determined to store an amount of energy that is sufficient for continuously providing the maximum nominal output current of the PFC circuit during one half wave of the AC input voltage without the voltage of output capacitor 218 dropping below a predetermined value. Output capacitor 218 may be considered the output of the PFC circuit 200. A voltage feedback signal is tapped of at output capacitor 218 and coupled to PFC controller circuit 214 via a feedback resistor 220, for providing a signal representative of the DC voltage at output capacitor 218. Feedback resistor 220 may include or be part of a voltage divider (not shown in the figure). A DC/DC-converter 222 is coupled to the output capacitor 218, providing one or more output voltages to electronic circuits (not shown in the figure). DC/DC-converter 222 does not form part of the PFC circuit 200 and is illustrated only as an exemplary electronic load of the PFC circuit 200.

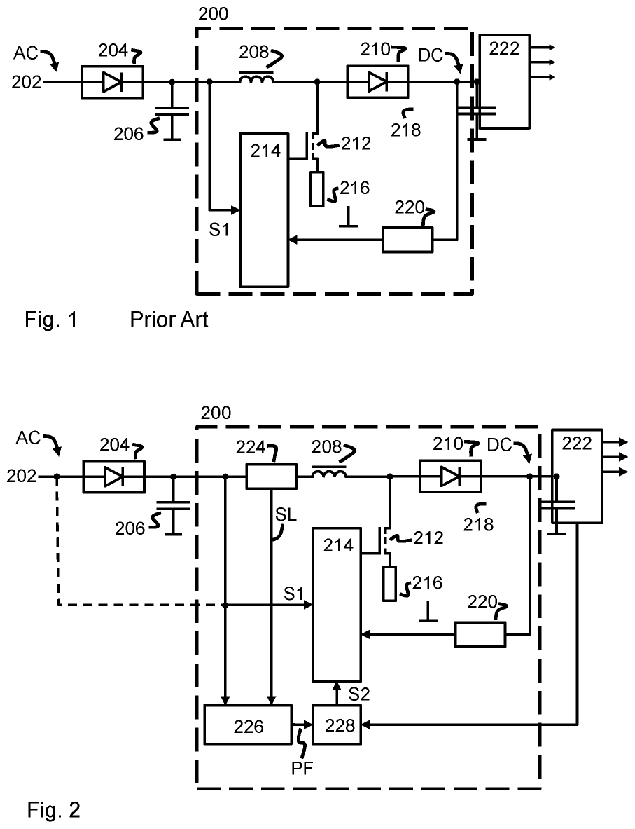

FIG. 2 shows an exemplary schematic diagram of a PFC circuit 200 in accordance with one or more aspects of the present invention. The general circuit corresponds to the PFC circuit described with reference to FIG. 1, with an input 202, an input rectifier 204, and input capacitor 206, an inductor 208, a boost rectifier 210, a boost switch 212, a PFC controller circuit 214, a current sense resistor 216, an output capacitor 218 and a feedback resistor 220 arranged and coupled in essentially the same ways as in the known PFC circuit.

However, unlike known from conventional PFC circuits, a current sensing means 224 is coupled between input capacitor 206 and inductor 208, for providing a signal SL representing the momentary current flowing through inductor 208. Current sensing means 224 may be implemented though a resistor across which a differential signal may be sensed, by an inductively coupled sensor, e.g., a current transformer, or by any other current sensing means. Likewise, different from known PFC circuits an analyzer circuit 226 is provided, which receives the first input signal S1 and the inductor current signal SL, and is adapted to determine the power factor between the current at the output of input rectifier 204 and the corresponding AC voltage. In other words, analyzer circuit 226 determines the harmonics of the inductor current waveform in relation to the waveform of the rectified AC voltage. The analyzer circuit 226 may implement a Fast Fourier Transformation (FFT) or may comprise filter banks or tunable filters. A signal PF representing the power factor, or the harmonics, may be provided to a control circuit 228, which generates a second input signal S2 and provides the second control signal S2 to power factor controller circuit 214. Power factor controller circuit 214 controls or modifies the operation of the boost switch 212 in accordance with the second control signal S2, targeting to cause a current flow, at the input of the PFC circuit, that, during an AC input voltage half-wave having non-zero input current, has a waveform that at least partially or temporarily does not correspond to a scaled version of the waveform of the AC input voltage. The waveform not corresponding to a scaled version of the AC input voltage may take a shape that will, when analyzed together with the remainder of the half wave, in which the waveform of the input current corresponds to a scaled version of the AC input voltage, will have a power factor that lies above regulatory requirements. In other words, the second control signal reduces the power factor from its ideal value of 1 to a lower value that still complies with the regulatory requirements.

Depending on the respective PFC controller circuit and the general circuit design the first input signal S1 representing the momentary AC input voltage may be tapped off downstream of the rectifier, or upstream of the rectifier, as indicated by the dashed line in FIG. 2. If the AC input voltage upstream of the rectifier is used for the first input signal the signal may need to be linearly scaled and level-shifted, which is not shown in the figure.

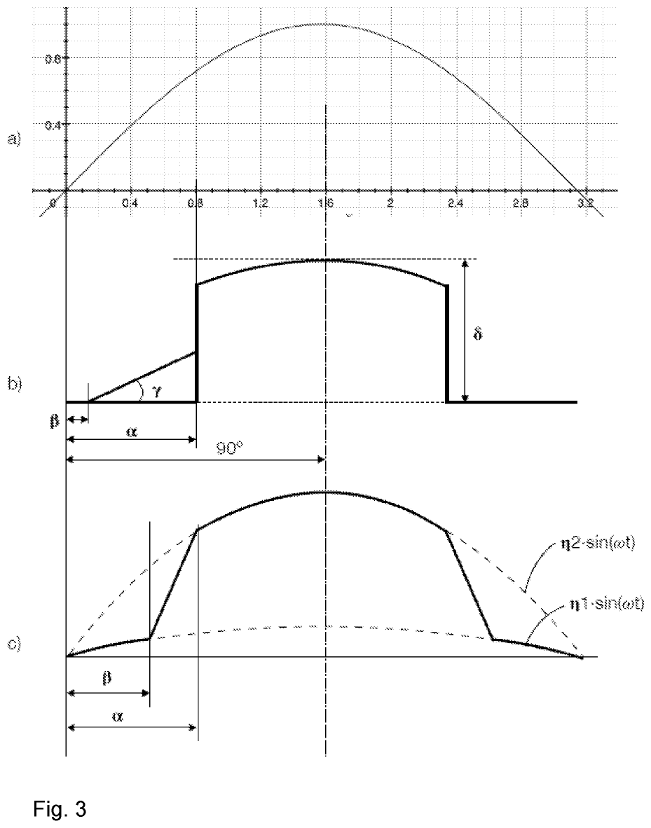

FIG. 3 shows various simplified exemplary input current waveforms of the PFC circuit, caused by applying different second signals to the power factor controller in accordance with the invention. In FIG. 3 a) a typical sine wave is shown, which is the target waveform of generally known PFC circuits. Achieving this waveform is also targeted by PFC circuits in accordance with the present invention when no second input signal S2 is received. When aligned with the corresponding sine wave of an AC input voltage the power factor is 1 or close to one, since no or only negligibly small harmonics are present.

FIG. 3 b) shows a first exemplary input current waveform that may be achieved by applying a corresponding second input signal S2 to the PFC circuit. As is readily visible in the figure, the waveform has a first section α which starts at the zero crossing of the sine wave and may have a variable length. During the first section β of the waveform the input current may be zero. In order to achieve zero input current, the boost switch may be inhibited. As some energy is still stored in output capacitor 218, i.e., output capacitor 218 still holds a non-zero voltage, and the momentary AC voltage at the input of the PFC circuit is lower than the non-zero voltage of the output capacitor 218, no current flows through boost rectifier 210, and consequently through input rectifier 204. Alternatively, with β reduced to zero, the input current during the first section α may straight away rise linearly at an angle γ. Angle γ may be variable. Achieving the linearly rising current may require operating the boost switch, but the switching frequency and/or on-times of the boost switch may be different from those required for achieving a sinusoidal input current waveform, thus reducing the losses generated in the boost switch.

The deadtime β, which starts at the zero crossing of the sine wave, may have a variable length. As mentioned above, during the deadtime β the operation of the boost switch is inhibited, thus eliminating the losses associated with operating the boost switch.

A second section of the input current waveform immediately follows the first section. During the second section the input current waveform may be sinusoidal, like in any known PFC circuit. However, the arching of the sinus in the second section of the input current waveform may be adjustable, e.g., determined by amplification factor δ. Depending on the value of δ the waveform of the input current in the second section may have a flat top, i.e., the waveform in the second section would correspond to a square wave, or may be fully sinusoidal.

The input current waveform may be symmetrical or asymmetrical, i.e., the waveform of the first and the second half of the half-wave may be identical or different, the latter shown in the figure.

FIG. 3 c) shows a second exemplary input current waveform that may be achieved by applying a corresponding second input signal S2 to the PFC circuit. Like in the waveform discussed with reference to FIG. 3 b), the waveform has a first section α which starts at the zero crossing of the sine wave and may have a variable length. During a fraction of the first section of the waveform the input current may rise linearly, very much like discussed with reference to FIG. 3 b). However, instead of having a deadtime β prior to the linearly rising section, the input current waveform during the lead-up time β in the figure is sinusoidal, albeit the input current has a much lower magnitude than in a PFC circuit of known design. At the end of the lead-up time β the input current rises linearly, similar as shown in FIG. 3 b), where the input current rises linearly after the deadtime β. At the end of the first section α of the input current waveform, i.e., during the second section of the input current waveform, the input current waveform is sinusoidal, like in any known PFC circuit. The amplitudes η1, η2 of the two sinusoidal parts and the durations of the first section α as well as the lead-up time β may be determined depending on the targeted amount of harmonics and the energy that needs to be transferred during one cycle.

The reduced magnitude of the sinusoidal fraction of the first section α may result in lower switching losses due to the lower momentary AC voltage during this time, and the lower input current associated therewith. The lower momentary AC voltage may also allow for a lower switching frequency and longer on-times of the boost switch while still resulting in a sufficiently sinusoidal input current waveform.

While the sinusoidal current during the lead-time β shown in FIG. 3 c) begins immediately at the zero-crossing of the sine wave of the AC input current it is also possible to add a deadtime, as shown in FIG. 3 b).

Varying the duration of the first section α and the deadtime or the lead-up time β, respectively, may yield different amounts of harmonics, as may targeting the PFC to have a symmetrical or an asymmetrical waveform.

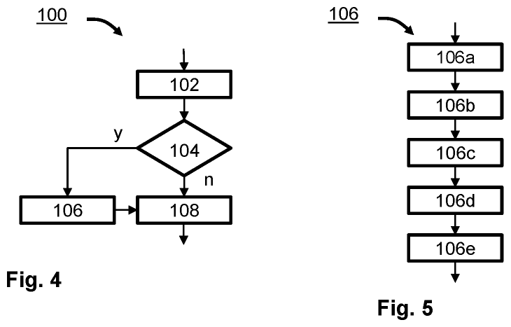

FIG. 4 shows a flow chart of an exemplary embodiment of a method 100 of operating a PFC circuit 200 in accordance with an aspect of the present invention. In step 102 a first input signal S1 representing the momentary AC input voltage at the PFC circuit or at the input of the power supply is received. As long as no second input signal S2 is received at the PFC circuit, “no”-branch of step 104, the operation of the boost switch 212, in step 108, is controlled in accordance with the first input signal S1 so as to cause a current flow, at the input of the power supply circuit, that has a waveform targeted to correspond to a scaled version of the waveform of the AC input voltage as represented by the first input signal S1. This corresponds to the operation of the boost switch 212 as found in conventional PFC circuits, i.e., the boost switch 212 that is connected to an inductor 180 is alternatingly opened and closed, for charging an output capacitor 218 via an output rectifier switch 210. The boost switch 212 is typically operated at a fixed frequency that is higher than the frequency of the AC input voltage present at the input of a power supply that comprises the PFC circuit.

If a second input signal S2 is received, “yes”-branch of step 104, the operation of the boost switch in step 108 is controlled or modified in step 106. Controlling or modifying the operation of the boost switch is targeted to cause a current flow, at the input of the power supply, that, during an AC input voltage half-wave having non-zero input current, has a waveform that at least partially or temporarily not corresponds to a linearly scaled version of the waveform of the AC input voltage. Controlling or modifying the operation of the boost switch may comprise modifying or replacing the first input signal S1. Modifying the first input signal may comprise multiplying the first input signal S1 with a factor or a time-dependent function.

FIG. 5 shows a more detailed flow chart of an exemplary controlling or modifying step 106 of FIG. 4. In step 106a the input current to the inductor 208 is sampled, and in step 106b an FFT analysis on the sampled current is performed. In step 106c the harmonics of the input current are compared against the regulatory limits, e.g., against the values for harmonics stipulated in the IEC61000-3-2 standard or comparable standards. In step 106d the critical harmonics, i.e., those harmonics that exceed the maximum permissible values are determined and evaluated, and in step 106e the control signal S2 is selected, adapted or modified targeting to bring those harmonics that exceeded the maximum permissible values below those values. Control signal S2 is then applied to the power factor controller 214, which operates the boost switch 212 targeting to cause an input current flow that, while not being a scaled version of the AC input voltage, has harmonics that stay below the regulatory maximum values.

The method discussed with reference to FIGS. 4 and 5 is executed repeatedly and, whenever the second control signal is received or present, the analysis of the resulting input current is repeated for every half-wave or every full-wave.

### LIST OF REFERENCE NUMERALS (PART OF THE DESCRIPTION)

100 method
102 receive first input signal
104 receive second input signal?
106 modify/replace first input signal
106a sample input current
106b perform FFT/harmonics analysis
106c compare against regulatory limits
106d determine/evaluate critical harmonics
106e select/adapt/modify second input signal
108 operate boost switch
200 power factor correction circuit
202 input
204 input rectifier
206 input capacitor
208 inductor
210 boost rectifier
212 boost switch
214 power factor controller
216 current sense resistor
218 output capacitor
220 feedback resistor
222 DC/DC-converter
224 current sensing means
226 analyzer circuit
228 control circuit
S1 first input signal
S2 second input signal
SL inductor current signal
PF power factor signal

1. Method of operating a switched-mode power factor correction circuit, the method comprising:
receiving a first input signal representing a momentary AC input voltage at the power factor correction circuit or at the input of the power supply, the first input signal further representing a target input current waveform of the power factor correction circuit,
operating, under control of a power factor controller, a boost switch for charging an output capacitor of the PFC circuit, the boost switch being operated at a frequency that is higher than a frequency of the AC input voltage, the operation of the boost switch being controlled in accordance with the first input signal so as to cause a current flow, at the input of the power supply, that has a waveform targeted to correspond to a scaled version of the waveform of the AC input voltage as represented by the first input signal, when no second input signal is received at the power factor controller,
wherein the method further comprises:
receiving a load-dependent second input signal at the power factor controller that replaces or modifies the first input signal and thus modifies the operation of the boost switch, targeting to cause a current flow, at the input of the PFC circuit or at the input of the power supply, that, during an AC input voltage half-wave having non-zero input current, has a waveform that at least partially or temporarily not corresponds to a scaled version of the waveform of the AC input voltage, while targeting to stay below the maximum permissible harmonic current per Watt and/or the maximum permissible harmonic current amplitude, for each harmonic for the present load.

2. Method according to claim 1, wherein receiving the second signal comprises receiving a second input signal at the power factor controller that has been selected or modified in accordance with an output load of the PFC circuit.

3. Method according to claim 1 or 2, wherein the second input signal is targeted to cause the waveform of the current flow, at the input of the power supply, to be symmetrical over a half-wave.

4. Method according to claim 2, further comprising:
analyzing the harmonics of the waveform of the input current to the PFC circuit or at the input to the power supply during a portion of a half-wave of the AC input voltage, and
receiving a second input signal, at the power factor controller, for the remaining portion of the half-wave of the AC input voltage, the second input signal being selected or generated in accordance with a power-dependent maximum permissible harmonic current amplitude per Watt output power and/or a maximum permissible harmonic current amplitude, targeting to stay below the maximum permissible harmonic current per Watt and/or the maximum permissible harmonic current amplitude, for each harmonic, averaged over the entire half-wave of the AC input voltage.

5. Method according to claim 2, further comprising:
analyzing the harmonics of the waveform of the input current to the PFC circuit or at the input to the power supply during at least the preceding half-wave of the AC input voltage, and
receiving a second input signal, at the power factor controller, for the present half-wave of the AC input voltage, the second input signal being selected or generated in accordance with a power-dependent maximum permissible harmonic current amplitude per Watt output power and/or a maximum permissible harmonic current amplitude, targeting to stay below the maximum permissible harmonic current per Watt and/or the maximum permissible harmonic current amplitude, for each harmonic, for the entire present half-wave of the AC input voltage.

6. Power factor correction circuit for actively controlling a waveform of an input current of an electric power supply connected to an AC voltage source, comprising an input rectifier, an input capacitor, an inductor, a boost switch, a boost rectifier.an output capacitor and a power factor controller, the power factor controller having a first input for receiving a first input signal representing a momentary AC input voltage at the PFC circuit or at the input of the power supply, the first input signal further representing a target input current waveform of the power factor correction circuit, the power factor controller being adapted to control the operation of the boost switch in accordance with the first input signal, targeting to cause an input current, at the input of the power supply, to have a waveform corresponding to a scaled version of the AC input voltage as represented by the first input signal,
wherein
the power factor controller is adapted to receive, at the first input or at a second input, a load-dependent second input signal that replaces or modifies the first input signal and thus modifies the operation of the boost switch, targeting to cause a current flow, at the input of the power supply, which, during an input voltage half-wave having non-zero input current, has a waveform that at least partially not corresponds to a scaled version of the waveform of the AC voltage source, while targeting to stay below the maximum permissible harmonic current per Watt and/or the maximum permissible harmonic current amplitude, for each harmonic for the present load.

7. Power factor correction circuit according to claim 6, further comprising a current sensing means adapted to measure a current flowing in the inductor, an analyzer circuit, coupled to the current sensing means and receiving the first input signal, wherein the analyzer circuit is adapted to determine harmonics in the current flowing through the inductor, and a control circuit, coupled to an output of the analyzer circuit and a second input of the power factor controller, wherein the control circuit is adapted to select or generate the second input signal in dependence of a number of harmonics in the current flowing through the inductor and a power-dependent maximum permissible harmonic current amplitude per Watt output power and/or a maximum permissible harmonic current amplitude.

8. Power factor correction circuit according to claim 7, further comprising a memory retrievably storing values, algorithms or curves describing the maximum permissible harmonic current per Watt output power and/or the maximum permissible harmonic current amplitude for each harmonic, which are provided to the analyzer circuit and/or the control circuit.

9. Power factor correction circuit according to claim 8, further comprising an interface for replacing or updating the values, algorithms or curves describing the maximum permissible harmonic current per Watt output power and/or the maximum permissible harmonic current amplitude for each harmonic.

10. Electric power supply, comprising an input coupled to an AC input voltage source, an output coupled to a non-linear load, and a power factor correction circuit according to one of claims 6 to 9.
